(19) United States
(12) Patent Application Publication
(10) Pub. No.: US 2005/0217183 A1
(43) Pub. Date: Oct. 6, 2005

(54) Composite casement or awning type window with wooden interior and exterior sides

(76) Inventor: Armando De Marco, Woodbridge (CA)

Correspondence Address: Thomas N. Young;Young & Basile P.C., Suite 624, 3001 West Big Beaver Road, Troy, MI, 48084, US

(21) Appl. No.: 10/819,337

(22) Filed: Apr. 6, 2004

(51) Int. Cl. E06B 1/04

(52) U.S. Cl. 49/504

(57) ABSTRACT

A composite window frame assembly for supporting a sash or similar pivoting window unit includes a unitary, rectangular metal or strong plastic frame having top, bottom, and side frame members. This frame has an exterior surface and an opposite interior surface. Four exterior window frame sections extend along and cover the exterior surface while four interior wooden frame sections extend along and cover the interior surface and are rigidly connected thereto. One of the two pairs of parallel frame members have attaching means for connecting hinge devices for pivotably connecting the sash or other window unit to this pair of frame members.

This application claims priority on the basis of an earlier Canadian patent application filed Feb. 16, 2004.

### BACKGROUND OF THE INVENTION

This invention relates to so-called casement and awning-type windows and, in particular, to windows of this type made with wooden frame members.

Casement and awning-type windows are known in the window industry and are used on both houses and commercial buildings. It is known to construct windows of this type using window frames, sashes and pivoting inner window units with rectangular frames made entirely or substantially of wooden frame members. It is also known to manufacture windows of this general type that are made entirely of or substantially of a suitable plastics material generally in the form of extruded, hollow plastic frame sections. There have also been window frames that combine together wooden frame members and elongate plastic members in the construction of the window frames.

In a sash or casement type window, the sash is pivotably mounted by means of hinges in a window frame and the sash is able to pivot around a vertical pivot axis from a closed position to an open position. An awning-type window is somewhat similar in its construction except that the pivoting window unit is arranged to pivot about a horizontally extending axis. The fixed window frame that extends around the sash or pivoting awning-type window is mounted in a window opening in the building in a suitable manner such as by nails or screws driven into adjoining supporting frames.

A casement window constructed from both wooden frame members and aluminum extrusions has been marketed by DeMarco Group Inc. of Woodbridge, Ontario. Each of the four frame sections of the rectangular frame is constructed from a combination of an interior wood frame member and an exterior, hollow aluminum frame member that is attached to the front surface of the wooden frame member. The hinge mechanisms for this window unit are mounted to the top and bottom frame sections. The operating hardware for the sash is anchored by means of screws that extend through the upper and bottom aluminum frame members. One difficulty with this construction, however, is that the entire outer side of the casement window is made of aluminum which may not have the same appeal for many house owners and window buyers as casement windows made entirely of wooden frame members.

It is also known to construct casement type and awning-type windows wherein the four frame sections that make up the rectangular frame are made substantially of or entirely of wood and this construction provides a very pleasing, high quality appearance on both the interior and exterior of the building in which such windows are installed. However, a difficulty with such windows is that the pivoting window unit during use can place substantial loads on the hinge mountings, particularly where the screws attach the hinge mountings to the wooden frame members. This can result in the failure of one or both of the hinge mountings for the sash or awning window.

U.S. Pat. No. 4,328,644 which issued May 11, 1982 to Philips Industries, Inc. teaches a casement type window that includes a rectangular window frame and a sash pivotably connected to this frame. The window frame is made with frame sections made of a prefabricated plastic shell located on the exterior side and a wooden frame section which faces towards the interior of the building. The plastic elements of the frame are brought together and heat fused at mitered corner abutment joints before being united to the wooden frame component. The sash is mounted by conventional top and bottom hinges and mounting links to swing about a vertical axis in the usual manner under the control of a conventional operating gear drive unit.

More recent U.S. Pat. No. 5,836,119 issued Nov. 17, 1998 to Lincoln Wood Products, Inc. also describes a sash-type window with a wooden rectangular frame extending around the sash that employs strips of extruded plastic material which are connected together by mechanical fasteners. In fact, the sash can be constructed of a plastic inner sash member to which interior wooden trim members are affixed on the inside and exterior trim members are affixed on the outside. The exterior trim members can be made of wood or extruded aluminum. A thermopane glass assembly is positioned between the exterior and interior trim members of the sash.

According to one aspect of the present invention, it is an object of this aspect to provide an improved composite window assembly that is constructed of frame members made of a suitable metal or strong plastics material that are able to provide the necessary support for hinge devices while at the same time having exterior and interior wooden frame sections to provide an overall pleasing appearance.

According to another aspect of the invention, it is an object of this further aspect to provide a window assembly that is provided with an improved, rectangular outer frame that includes composite frame members, each of which is made with a central longitudinal section made of a metal or a suitably strong plastic, exterior wooden frame sections covering the exterior surfaces of the central sections and interior wooden frame sections covering the interior surfaces of the central sections, this assembly also including an inner window frame that is pivotably mounted by means of hinge devices to the outer window frame.

### SUMMARY OF THE INVENTION

According to one aspect of the invention, there is provided a composite window frame assembly for supporting and for use with a sash or other pivoting window unit, this frame assembly being adapted for mounting in a building opening and including a unitary, rectangular metal frame made of parallel, metal, top and bottom frame members and two parallel, metal side frame members extending between and connecting the top and bottom frame members. The metal frame has an exterior surface and an opposite interior surface, both of which extend around the rectangular perimeter of the metal frame. Four exterior wooden frame sections extend along and cover the exterior surface and are rigidly connected to this exterior surface of the metal frame. Also, four interior wooden frame sections extend along and cover the interior surface and are rigidly connected to this surface of the metal frame. One of the two pairs of frame members comprising the top and bottom frame members and the side frame members has attaching devices for connecting hinge devices for pivotably connecting the sash or other pivoting window unit to the one pair of frame members.

Preferably, all the frame members of the metal frame are hollow, tubular frame members having a substantially rectangular transverse cross-section and the frame members are made of aluminum or aluminum alloy.

According to another aspect of the invention, a window assembly for mounting in a building opening includes an outer, rectangular window frame adapted for mounting fixedly in the building opening, this window frame including parallel top and bottom frame members and two parallel side frame members extending between and rigidly connecting the top and bottom frame members. At least one pair of the pair of top and bottom frame members and the pair of side frame members comprises two composite frame members, each of which includes a central longitudinal section made of at least one suitable strong material selected from the group of materials consisting of a metal and a plastics material capable of securely and rigidly holding mechanical fasteners for a hinge device. There is also an exterior, wooden longitudinal frame section that covers an exterior surface of the central longitudinal section and is rigidly connected thereto. An interior wooden longitudinal frame section covers an interior surface of a central longitudinal section and is rigidly connected thereto. The exterior and interior surfaces of the central longitudinal section are located on opposite sides thereof. A rectangular, inner window frame is adapted for and is sized for mounting in the outer window frame and has at least one glass pane mounted therein. There are two hinge devices pivotably connecting the inner window frame to the outer window frame with each hinge device having an outer window hinge section connected to the central longitudinal section of a respective one of the composite frame members by means of at least one mechanical fastener. Each hinge device also has an inner window hinge section fixedly connected to the inner window frame.

Preferably each central longitudinal section is made of extruded aluminum or aluminum alloy and is hollow and the central longitudinal section has a substantially rectangular transverse cross-section.

According to a further aspect of the invention, there is provided a window assembly for mounting in a building opening that includes an outer window frame for mounting fixedly in the building opening. This window frame includes two pairs of frame members with the frame members of each pair being spaced-apart and substantially parallel to one another. Each frame member comprises a central longitudinal section made of at least one suitable, strong material selected from the group of materials consisting of a metal and a plastics material capable of securely and rigidly holding mechanical fasteners for a hinge device. An exterior wooden longitudinal frame section covers and is fixedly connected to an exterior surface of the central longitudinal section. An interior wooden longitudinal frame section covers and is fixedly connected to an interior surface of the central longitudinal section. The exterior and interior surfaces are located on opposite sides of the central longitudinal section. An inner window frame is adapted for and is sized for mounting in the outer window frame and has at least one glass pane mounted therein. Two hinge devices pivotably connect the inner window frame to one of the two pairs of frame members and each hinge device has an outer window hinge section connected to the central longitudinal section of a respective one of the frame members of the one pair of frame members by at least one of the mechanical fasteners. An inner window hinge section of each hinge device is pivotably connected to the outer window hinge section and is fixedly connected to the inner window frame.

Further features and advantages will become apparent from the following detail description taken in conjunction with the accompanying drawings.

### BRIEF DESCRIPTION OF THE DRAWINGS

FIG. 1 is an exterior view of a composite window frame assembly constructed in accordance with the invention, this view not including a sash or other pivoting window unit adapted for use in the illustrated assembly;

FIG. 2 is a horizontal cross-section of the window frame assembly of FIG. 1, this view taken along the line II-II of FIG. 1;

FIG. 3 is a vertical cross-sectional view of the sill portion of the window frame assembly of FIG. 1, this view being taken along the line III-III of FIG. 1;

FIG. 4 is a schematic exterior view of a window assembly that includes the window frame assembly of FIG. 1 and a window sash in an open position;

FIG. 5 is a transverse cross-section of a preferred metal frame member that can be used in the window frame assembly of FIGS. 1 to 3;

FIG. 6 is a vertical cross-section similar to FIG. 3 but also showing a window sash in its closed position; and

FIG. 7 is a horizontal cross-section of the casement or sash-type window of FIG. 4, this view being taken along the line VII-VII of FIG. 4.

### DETAILED DESCRIPTION OF PREFERRED EMBODIMENTS

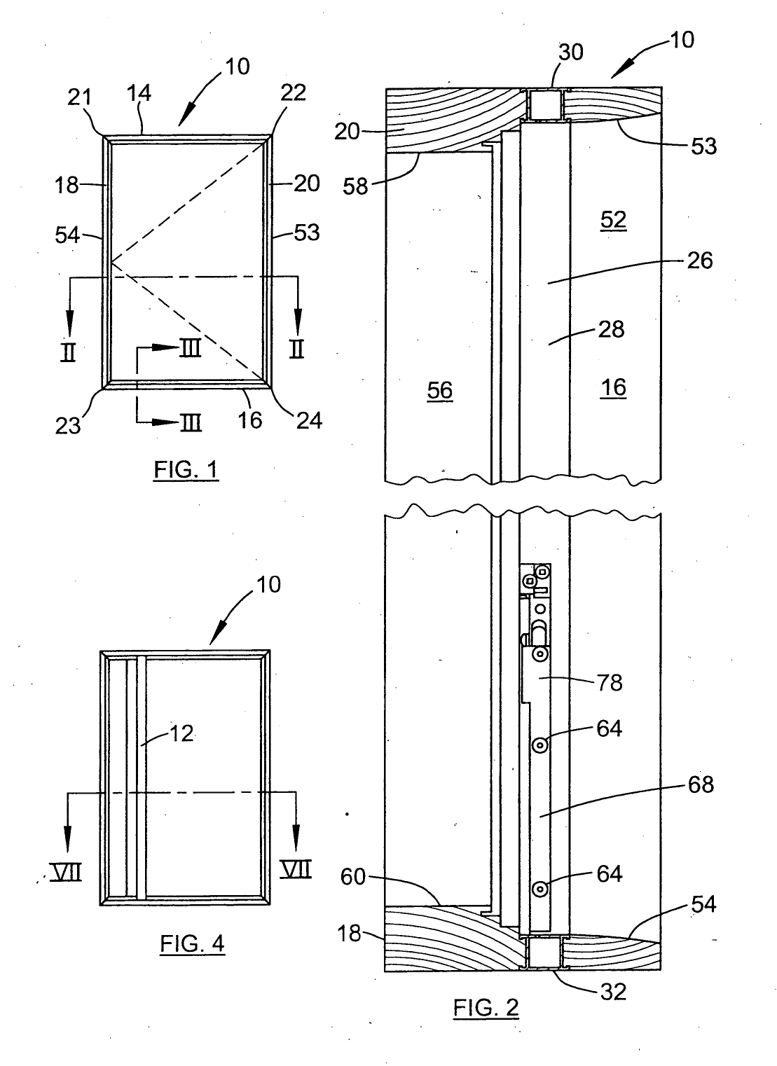

Illustrated in FIGS. 1 and 2 is a composite window frame assembly 10 constructed in accordance with the invention which can be used for supporting and for use with a sash 12 shown schematically in FIG. 4. The frame assembly 10 is adapted for mounting in a building opening in the usual, well known manner. This building opening is normally framed by wooden or metal support frame members extending both horizontally and vertically, these support frame members forming a rectangular opening dimensioned to receive the window frame assembly 10. It will be understood that the window frame assembly can come in a variety of sizes in order to fit window openings of a variety of sizes in residential and/or commercial buildings. The window frame assembly includes a top or head frame section 14, a bottom or sill frame section 16 and two, parallel side frame sections 18 and 20. The top and bottom frame sections 14 and 16 are parallel to one another and are connected to each other by the side frame sections. The four frame sections 14. 16, 18, 20 meet at four corners where normally the four joints 21 to 24 are mitered joints.

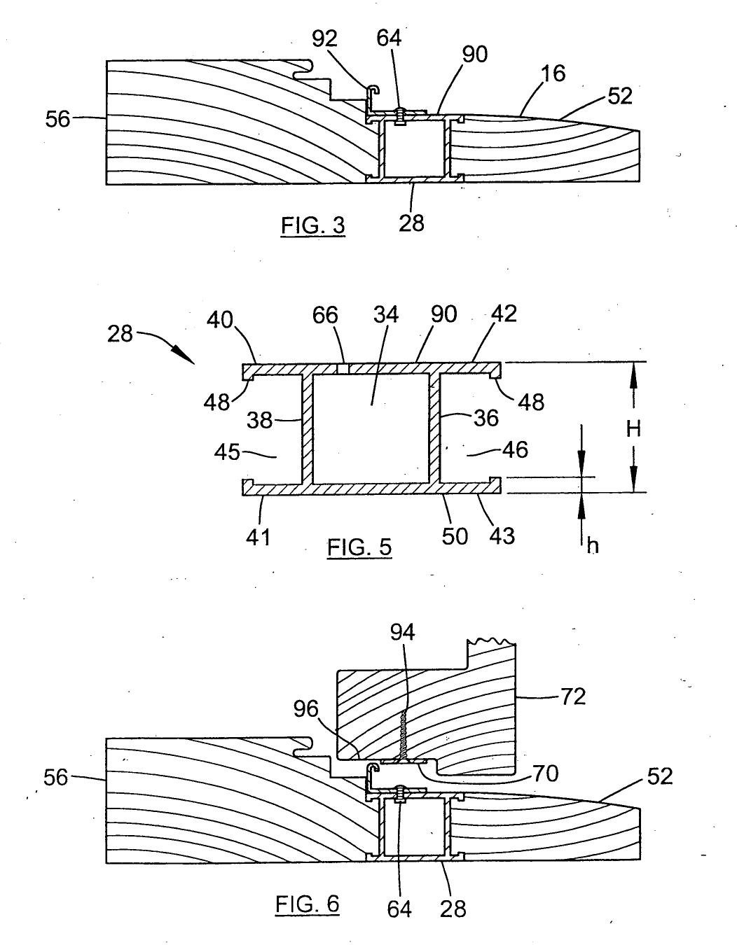

The construction of each of the frame sections 14, 16, 18, 20 can be similar except for differences noted hereinafter. Accordingly, it shall be sufficient to describe in detail the construction of the bottom or sill frame section 16 which is illustrated in FIG. 3. The preferred window frame assembly 10 includes a unitary, rectangular metal frame indicated generally at 26 in FIG. 2. Although the preferred frame 26 is made of a suitable metal such as aluminum or aluminum alloy, it is also possible to make this frame from a suitable strong plastics material, such as polyvinylchloride (PVC). The metal or the plastics material for the frame 26 must be capable of securely and rigidly holding mechanical fasteners for a hinge device as explained further below. The metal or plastic frame 26 includes parallel, top and bottom frame members with the bottom frame member 28 shown clearly in FIGS. 2 and 3. The frame 26 also includes two parallel metal or plastic side frame members 30 and 32, the cross-sections of which can be seen in FIG. 2. The bottom frame member 28, the top frame member and the side frame members 30 and 32 can all be of identical construction except of course for their length which can vary and they can be joined together at their adjacent corners by welding or by the use of suitable corner connectors, such as metal angle members (not shown).

The cross section of one preferred form of bottom frame member 28 is shown in detail in FIG. 5 and, as indicated, the other frame members forming the rectangular metal frame can have an identical cross-section. The frame member 26 is a hollow, tubular frame member that forms an elongate central passage 34 which is rectangular in cross-section, as shown. The frame member has an exterior with a substantially rectangular transverse cross-section, this exterior including an exterior surface 36 and an opposite interior surface 38. Thus, for purposes of the present description and this invention, it will be understood that the exterior and interior surfaces of each frame member are located on opposite sides thereof. Also, as will be clear from the following description, each of the frame members 28, 30, 32 can be considered a central, longitudinal section of its respective frame section 14 to 20, since it is positioned centrally in the frame section in the direction extending from the exterior of the frame assembly to the interior of the frame assembly. The preferred frame member 28 of FIG. 5 has both its interior and exterior sides provided with top and bottom parallel edge flange portions indicated at 40 to 43. The top and bottom edge flange portions 40, 41 that project from the edges of the interior surface 38 define a first open connecting channel 45. Similarly, the edge flange portions 42, 43 projecting out from edges of the exterior surface 36 find a second open connecting channel 46. Preferably, each of these edge flange portions 40 to 43 is formed with an inwardly projecting lip or flange 48. Thus, the lips 48 on the exterior side project towards one another as do the lips 48 on the interior side. In one particular preferred embodiment made of aluminum alloy, the height h indicated in FIG. 5 is 2.54 mm while the thickness of the web 50 that extends to the lip 48 is only 1.27 mm. This particular frame member 28 has an overall height H of 22.23 mm and a transverse width of 41.28 mm. It will be appreciated that it is also possible to construct each of the frame members 28, 30, 32 with only top and bottom, parallel edge flange portions on either the exterior or on the interior side of the frame member, in which case alternative forms of mechanical connectors for the wooden frame members described hereinafter can be used.

Returning to FIG. 2 and 3, the window frame assembly 10 is also provided with four exterior window frame sections with a bottom wooden frame section indicated at 52 and two-side wooden frame sections indicated at 53 and 54. These wooden frame sections extend along and cover the exterior surfaces of the rectangular metal or plastic frame formed by the aforementioned metal or plastic frame members including members 28, 30, 32. Also, these wooden frame sections are rigidly connected to the exterior surface of the metal or plastic frame, preferably by means of the aforementioned edge flange portions 42, 43.

The frame assembly 10 also has four interior wooden frame sections including bottom wooden frame section 56 shown in FIGS. 2 and 3, and side wooden frame sections 58 and 60. These wooden frame sections extend along and cover the interior surface of the above described metal or plastic frame. They are rigidly connected to this interior surface, preferably by means of the edge flange portions 40, 41 of the metal or plastic frame members.

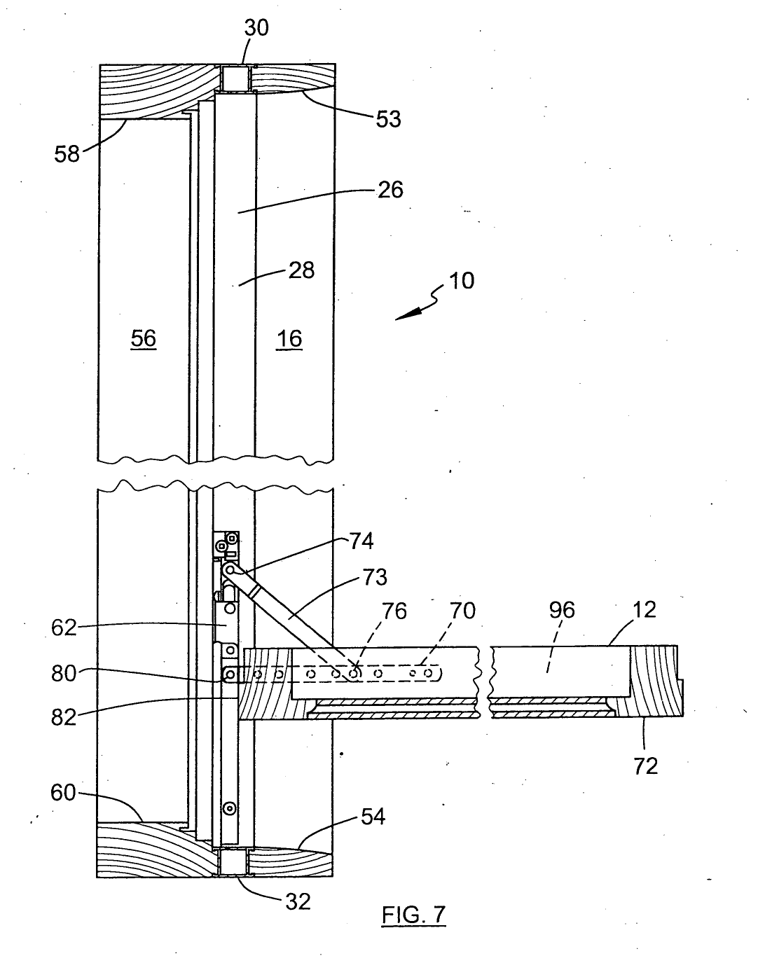

In the case of a sash-type window, the type illustrated in the drawings, the top and bottom frame members of the metal frame 26 have attaching means for connecting hinge devices, such as the hinge device 62 shown in FIG. 7. This attaching means can be rivet or screw holes formed in the bottom frame member 28 and the corresponding top frame member. A hinge track mounting rivet is indicated at 64 in FIG. 3 and at least two of these rivets 64 are shown in FIG. 2. A hole 66 for one of the rivets 64 is shown in FIG. 5. Two of the hinge devices 62 are used to connect the sash or other pivoting window unit to the metal or plastic frame members. Of course, in the case of an awning-type window that pivots about a horizontal pivot axis, the two hinge devices will connect the pivoting inner window unit to the two side frame members 30, 32. Preferably there are at least two or three of the holes 66 formed in the frame member for attaching an outer window hinge section 68 of the hinge device to the frame member or central longitudinal section by means of two or three mechanical fasteners such as rivets or screws. The illustrated hinge device also has an inner window hinge section 70 which is fixedly connected to the inner window frame or sash frame 72.

The hinge devices 62 can be of standard construction for a hinge mechanism used on a sash or casement window. Accordingly, a detailed description of the hinge device 62 herein is deemed unnecessary. In addition to the aforementioned hinge section 62 and hinge section 70, the illustrated hinge device also has a connecting link 73 which is pivotably connected at each end, these pivotable connections being indicated at 74 and 76 in FIG. 7. Also, the preferred hinge device 62 includes a hinge track 78 which is part of the outer window hinge section 68 and which is connected by the rivets 64 to the adjacent metal or plastic frame member. A hinge pin member 80 is slidably mounted on the hinge track 78 and pivotably connects one end of the hinge section 70 to the track. In this way, the vertical side 82 of the sash 12 can move inwardly towards the vertical center of the window frame as it is pivoted to the open position shown in FIG. 7. It will be understood that standard sash window hardware (not shown) can be installed on the window assembly in order to pivot the sash or awning type window between its open and closed positions. The window operator can, for example, have a rotatable handle that operates a gear mechanism and arm which is able to pivot the sash or awning window between the open and closed positions.

Although the illustrated, preferred window assembly has a window frame with a composite frame member on each of its four sides, it will be appreciated that it is also possible to construct an outer window frame which has a central longitudinal section made of metal or plastic on only two of its four sides, for example, either the top and bottom frame members or the two side members, as the hinge devices are only connected to two of the four sides and it is the sides to which the hinge members are connected that should have a suitably strong, central longitudinal section for connecting the outer window hinge section by means of rivets or screws. If the metal or plastic central sections are only used on two of the frame members, the other two parallel frame members can be constructed entirely of wood, if desired.

With respect to the construction of the sash, which can also be referred to as a rectangular, inner window frame, it can be made entirely of wooden frame members as shown, if desired, or it can be made of metal or plastic frame members formed by extrusion, preferably hollow frame members. However, the use of a wooden sash is preferred since this enhances the overall appearance of the window assembly. The sash 12 preferably has at least one glass pane mounted therein and it can, of course, have two or more glass panes, if desired.

The central longitudinal section of each frame member has an inner surface 90 which faces the inner window frame in a closed position of the window assembly. It will be understood that the outer window hinge section 68 is mounted directly to its respective adjacent inner surface 90 by two or more of the rivets or screws. Also visible in FIG. 3 is a projecting section 92 of the outer window hinge section, this hinge section extending upwardly from the inner surface 90 along the interior edge thereof.

With reference to FIG. 6, there can be seen one of the mounting screws 94 for attaching the hinge section 70 to the bottom of the wooden sash. There is also shown a bottom recess or cut out 96 extending along the bottom of the sash. This recess or cut-out accommodates the hinge section 70.

It will be appreciated that other forms of mechanical connectors can be used to attach the interior and exterior wooden frame sections to the metal or plastic central frame member. For example, instead of using the illustrated edge flange portions, it is possible to employ edge flanges formed on the central frame member that are clamped into the adjacent edges of the wooden frame members by a suitable clamping tool or a press. Alternatively, the interior or exterior wooden frame sections can be attached to the central frame member by mechanical fasteners such as suitable screws.

Any type of suitable wood can be used for the wooden frame sections, including both soft and hard woods.

It will be appreciated that the present invention provides a very strong window construction in that each hinge device 62 is mounted and connected to a suitable, strong metal or plastic frame member located centrally on the adjacent window frame section. It will be understood that the sash or awning type window can be relatively heavy and, when pivoted to the open position, the sash or movable window unit can place considerable strain on the window hinges. However, unlike previous all-wood window frames, the window frame of the present invention is able to properly hold and secure the screws or rivets so that they will not be pulled out of the window frame section to which they are connected.

It will be appreciated by those skilled in the construction of casement-type windows that various modifications and changes can be made to the described and illustrated window frame assembly and composite window frame without departing from the spirit and scope of this invention. Accordingly, all such modifications and changes as fall within the scope of the appended claims are intended to be part of this invention.

1. A composite window frame assembly for supporting and for use with a sash or other pivoting window unit, said frame assembly being adapted for mounting in a building opening and comprising:
a unitary, rectangular metal frame made of parallel, metal, top and bottom frame members and two parallel, metal side frame members extending between and connecting said top and bottom frame members, said metal frame having an exterior surface and an opposite interior surface both of which extend around the rectangular perimeter of the metal frame;
four exterior wooden frame sections extending along and covering said exterior surface and rigidly connected to said exterior surface of said metal frame,
four interior wooden frame sections extending along and covering said interior surface and rigidly connected to said interior surface of said metal frame; and
wherein one of the two pairs comprising the top and bottom frame members and the side frame members having attaching means for connecting hinge devices for pivotally connecting said sash or other pivoting window unit to said one pair of frame members.

2. A composite window frame assembly according to claim 1 wherein all of said frame members of the metal frame are hollow, tubular frame members having a substantially rectangular transverse cross-section and said frame members are made of aluminum or aluminum alloy.

3. A composite window frame assembly according to claim 2 wherein each frame member of said metal frame on at least one of exterior and interior sides thereof is provided with top and bottom, parallel edge flange portions defining an open connecting channel, said edge flange portions connecting an adjacent one of the wooden frame sections to the respective frame member.

4. A composite window frame assembly according to claim 1 wherein each frame member of the metal frame on both exterior and interior sides thereof is provided with top and bottom parallel edge flange portions defining exterior and interior open connecting channels, the edge flange portions of each connecting channel connecting an adjacent one of the wooden frame sections to the respective frame member.

5. A composite window frame assembly according to claim 2 including two hinge devices connected respectively to the frame members of said one pair and wherein said attaching means include connector holes formed on inner surfaces of said frame members of said one pair that face towards the center of the metal frame and metal fasteners that extend from said hinge devices and through said connector holes.

6. A composite window frame assembly according to claim 5 wherein said metal fasteners are rivets and each hinge device includes a hinge track which is rigidly connected to its respective frame member by two or more of said rivets.

7. A composite window frame assembly according to claim 5 wherein said metal fasteners are screws and each hinge device includes a hinge track which is rigidly connected to its respective frame member by two or more of said screws.

8. A window assembly for mounting in a building opening comprising:
a rectangular, outer window frame adapted for mounting in said building opening, said window frame including parallel top and bottom frame members and two parallel side frame members extending between and rigidly connecting said top and bottom frame members, at least one pair of the pair of top and bottom frame members and the pair of side frame members comprising two composite frame members each of which includes a central longitudinal section made of at least one suitable, strong material selected from the group of materials consisting of a metal and a plastics material capable of securely and rigidly, holding mechanical fasteners for a hinge device, an exterior wooden longitudinal frame section covering an exterior surface of said central longitudinal section and rigidly connected thereto, and an interior wooden longitudinal frame section covering an interior surface of said central longitudinal section and rigidly connected thereto, said exterior and interior surfaces being located on opposite sides of the central longitudinal section;
a rectangular, inner window frame adapted for and sized for mounting in said outer window frame and having at least one glass pane mounted therein; and
two hinge devices pivotably connecting said inner window frame to said outer window frame, each hinge device having an outer window hinge section connected to the central longitudinal section of a respective one of the composite frame members by means of at least one mechanical fastener and an inner window hinge section connected to said inner window frame.

9. A window assembly according to claim 8 wherein each central longitudinal section is made of extruded aluminum or aluminum alloy and is hollow.

10. A window assembly according to claim 8 wherein each central longitudinal section has a substantially rectangular transverse cross-section and an inner surface facing the inner window frame in a closed position of the window assembly, and wherein each outer window hinge section is mounted directly to a respective adjacent inner surface by two or more of said mechanical fasteners.

11. A window assembly according to claim 8 wherein each central longitudinal section on both exterior and interior surfaces thereof is provided with two parallel edge flange portions defining exterior and interior open connecting channels, the edge flanges of each connecting channel connecting an adjacent one of the wooden longitudinal frame sections to the respective central longitudinal section.

12. A window assembly according to claim 9 wherein each outer window hinge section comprises a hinge track having a hinge pin member slidably mounted thereon and the respective inner window hinge section is pivotably connected at one end to said hinge pin member.

13. A window assembly according to claim 9 wherein said inner window frame is a window sash that is pivotably connected by said hinge devices to said top and bottom frame members and wherein said window sash is made of wooden frame members.

14. A window assembly according to claim 8 wherein both pairs of frame members consist of composite frame members each of which includes said central longitudinal section, said exterior wooden longitudinal frame section, and said interior wooden longitudinal frame section, and wherein the four central longitudinal sections are rigidly connected to one another where they meet at the four corners of the window frame.

15. A window assembly for mounting in a building opening comprising:
an outer window frame for mounting in said building opening, said window frame including two pairs of frame, members with the frame members of each pair being spaced-apart and substantially parallel to one another, each frame member comprising a central longitudinal section made of at least one suitable, strong material selected from the group of materials consisting of a metal and a plastics material capable of securely holding mechanical fasteners for a hinge device, an exterior wooden longitudinal frame section covering and fixedly connected to an exterior surface of said central longitudinal section, and an interior wooden longitudinal frame section covering and fixedly connected to an interior surface of said central longitudinal section, said exterior and interior surfaces being located on opposite sides of the central longitudinal section;
an inner window frame adapted for and sized for mounting in said outer window frame and having at least one glass pane mounted therein; and
two hinge devices pivotably connecting said inner window frame to one of said two pairs of frame members, each hinge device having an outer window hinge section connected to the central longitudinal section of a respective one of the frame members of said one pair of frame members by at least one of said mechanical fasteners and an inner window hinge section pivotably connected to said outer window hinge section and fixedly connected to said inner window frame.

16. A window assembly according to claim 15 wherein each central longitudinal section is made of extruded aluminum or aluminum alloy and is a hollow tubular member.

17. A window assembly according to claim 16 wherein each central longitudinal section has a substantially rectangular transverse cross-section and an inner surface facing the inner window frame in a closed position of the window assembly and wherein each outer window hinge section is mounted directly to a respective adjacent inner surface of its central longitudinal section by two or more of said mechanical fasteners.

18. A window assembly according to claim 15 wherein each central longitudinal section on both exterior and interior surfaces thereof is provided with two parallel edge flange portions defining exterior and interior open connecting channels, the edge flanges of each connecting channel connecting an adjacent one of the wooden longitudinal frame sections to the respective central longitudinal section.

19. A window assembly according to claim 16 wherein said mechanical fasteners are rivets that extend through attachment holes formed in the central longitudinal sections of one of said two pairs of frame members.

20. A window assembly according to claim 16 wherein said inner window frame is a sash and said one pair of said frame members to which the two hinge devices are connected are top and bottom frame members that extend horizontally during use of said window assembly.
